(19) United States
(12) Patent Application Publication
(10) Pub. No.: US 2007/0174154 A1
(43) Pub. Date: Jul. 26, 2007

(54) Methods and systems for aligning business interests

(75) Inventors: Thomas H. Roberts, Midland, TX (US); Stephen K. London, Katy, TX (US); Richard H. Tate, Brownfield, TX (US); E. Alan Coats, The Woodlands, TX (US); Stephen L. Webb, Lubbock, TX (US); William H. Tabor, Levelland, TX (US)

Correspondence Address: CONLEY ROSE, P.C.;David A. Rose, PO BOX 3267, HOUSTON, TX, 77253-3267, US

(73) Assignee: Halliburton Energy Services, Inc., Houston, TX (US)

(21) Appl. No.: 11/323,293

(22) Filed: Dec. 30, 2005

(51) Int. Cl. G07F 19/00

(52) U.S. Cl. 705/30

(57) ABSTRACT

Methods and systems of dynamically aligning interests in a business relationship are disclosed. Some embodiments provide a method of profit sharing between business entities, comprising: determining a baseline cost for a service or product; determining a savings relative to that baseline cost; and allocating a portion of that savings to a provider of that service or product as an increased profit multiplier to a burdened cost of that service or product.

### BACKGROUND

Business relationships often become adversarial in nature because the parties to the relationship tend to view the relationship as a sequence of unrelated, basic transactions. In each transaction, a purchaser attempts to acquire satisfactory goods or services for the lowest possible price, while the seller attempts to provide those goods or services at the highest possible profit. The resulting conflict over sales price causes the parties to exert whatever available power they have to dominate the transaction. For example, where the seller has advantages such as control over supply or control over purchaser awareness, the seller tends to raise prices. Conversely, where the purchaser has advantages such as choice of multiple suitable alternatives, the purchaser tends to force prices lower.

Adversarial business relationships can be inefficient. For example, each party to a business relationship may be hurt by the other party's losses or low profitability. As another example, cycles in the economy or a particular industry may shift power back and forth between parties, potentially causing each party to suffer from changing conditions due to an inability to cope with rapidly changing conditions, or simply due to an inability to make long-term plans for equipment and staffing levels.

### BRIEF DESCRIPTION OF THE DRAWINGS

A better understanding of the various disclosed invention embodiments can be obtained when the following detailed description is considered in conjunction with the following drawings, in which:

FIG. 1 is a flowchart of an illustrative business interest alignment method;

FIG. 2 shows illustrative business party interests;

FIG. 3 shows illustrative aligned interests;

FIG. 4 shows illustrative metrics for the aligned interests of FIG. 3;

FIG. 5 shows illustrative metric-based incentives;

FIG. 6 shows an illustrative traditional invoice;

FIG. 7 shows an illustrative aligned-interest invoice;

FIG. 8 shows a block diagram of an illustrative business interest alignment system; and

FIG. 9 shows an illustrative implementation of a business interest alignment system;

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Disclosed herein are methods and systems for aligning interests in business relationships. Disclosed method embodiments enable business relationships to operate as partnerships rather than adversarial relationships. Parties to the business relationship formulate aligned interests, specify metric-based incentives for those interests, and formalize the relationship accordingly. In some implementations, the formalized relationship employs an invoicing system to change the parties' behaviors in a manner that increases profits for each party.

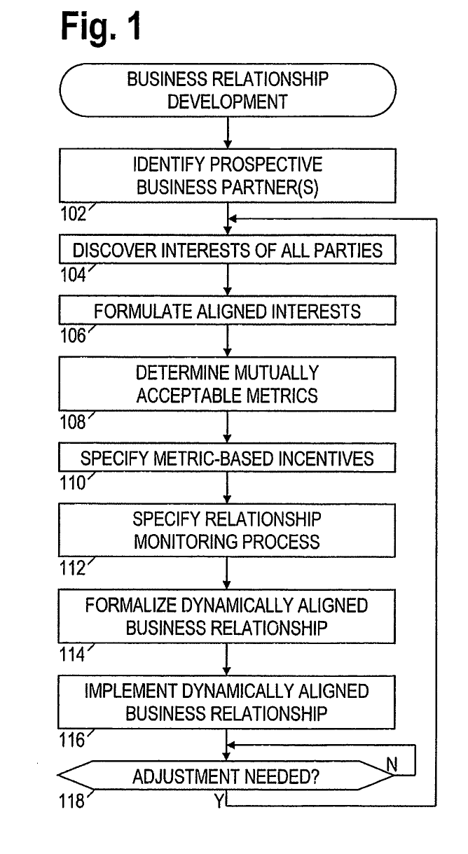

FIG. 1 shows an illustrative method of aligning business interests when developing a business relationship. While the illustrated method is applicable to business relationships of any kind, it is more particularly suited to ongoing business relationships (so that behavior changes are rewarded). Beginning in block 102, one party identifies prospective partners for business interest alignment. The prospective partner may be a party to a currently adversarial business relationship, or a previously unknown party having some service, product, or market to offer. For example, the prospective partner may be existing or potential vendors, customers, or competitors. Experience has shown that a high degree of trust is desirable, making existing vendors and customers particularly good candidates for the disclosed methods. In the ensuing discussions, a proposed relationship between an oil field operator and a service provider will be used as an example.

In block 104, party representatives meet to discover the interests of all parties. These interests are the material from which aligned interests are forged, so open discussions are desirable. Of course, interests such as profit or return on investment are expected to be a commonly discovered interest, but the discussions should not stop there. A larger group of discovered interests may lead to a larger number of aligned interests that benefit all parties to the relationship.

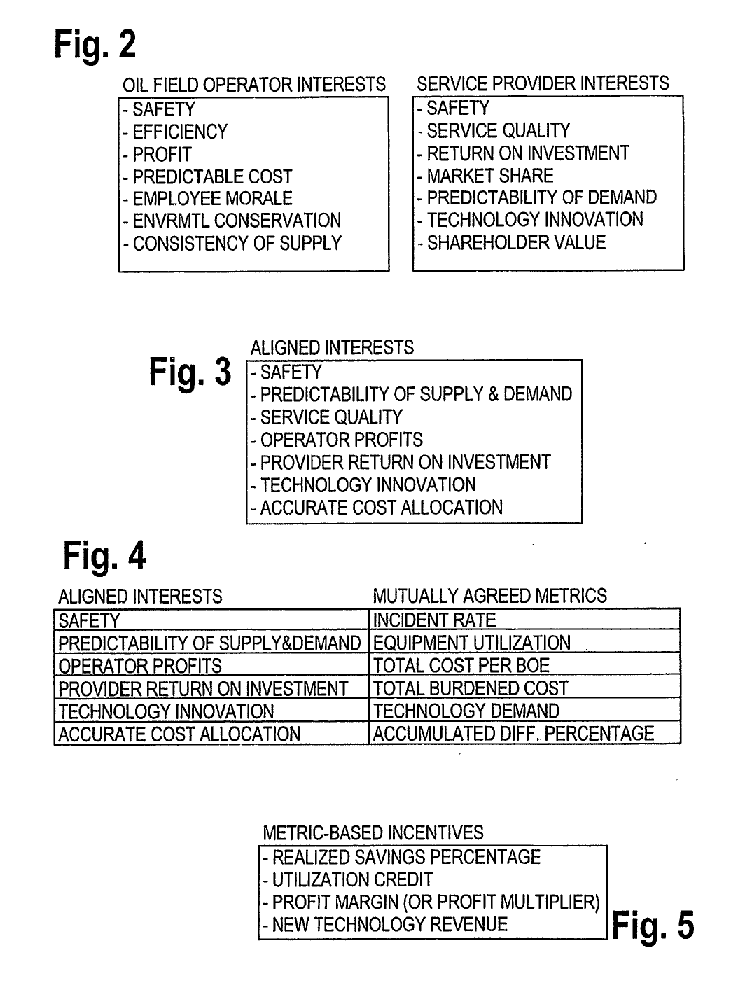

FIG. 2 shows an illustrative set of discovered interests for an oil field operator and a service provider. In the illustrative example, the oil field operator has identified safety, efficiency, profit, predictable costs, employee morale, environmental conservation, and consistency of supply as core interests. The service provider has identified safety, service quality, return on investment, market share, predictability of demand, innovation, and shareholder value as core interests. Note that these lists are not necessarily exhaustive, but they serve as a starting point for identifying potentially alignable interests.

In block 106 (FIG. 1), the parties' representatives formulate aligned interests. Aligned interests are interests that, when served, provide a benefit for each party. Aligned interests may be formulated by examining each of the discovered interests from the previous step, and identifying a corresponding interest that is served for the other party(s).

FIG. 3 shows illustrative aligned interests for the oil field operator-service provider example. In the example, safety, predictability, operator profits, provider return on investment, technology innovation, service quality, and accurate cost allocation have been listed as aligned interests. Safety appears as a interest for both parties in FIG. 2, and thus provides a clear benefit to both parties. Predictability of supply and demand appears as an aligned interest because when the service provider's predictability interest is served, they are able to lower their costs and thus able to benefit the operator's profit interest. Similarly, the operator benefits from a consistent, predictable availability of services, which lowers the operator's costs.

Service quality appears as an aligned interest because the operator benefits from efficient and effective services, and the provider benefits from earning a reputation for providing such quality. Operator profits and the service provider's return on investment are both aligned interests because they assure that each party continues to be available for future business transactions. Innovation by the service provider is an aligned interest because it increases service efficiency, one of the operator's interests. (Note, however, that the research associated with innovation increases short-term costs. This issue is addressed later.)

Additional aligned interests may be formulated as additional interests are discovered. For example, accurate cost allocation is listed in FIG. 3 as an aligned interest because it facilitates metric determination, which is a mutually beneficial interest resulting from a subsequent portion of the illustrated methods. The illustrated methods are preferably dynamic, allowing for adaptation and refinement of previously performed phases.

In block 108 (FIG. 1), the parties' representatives determine mutually acceptable metrics—measures of how well the mutually aligned interests are being served. Though many measures may exist for each aligned interest, the chosen metrics are preferably the result of a structured and verifiable information-gathering and calculation process. Moreover, the most desirable metrics are those that are tied to factors that the parties' combined behaviors can affect in a determinative fashion.

For example, FIG. 4 shows metrics for the aligned interests of FIG. 3. The metric for safety is the “reportable incident” rate, which is the number of safety incidents reported in compliance with OSHA (Occupational Safety and Health Administration) regulations in a given reporting period. Existing regulatory compliance procedures provide a structured and verifiable information gathering process, and both the service provider and the oil field operator can take steps to improve compliance with safety procedures to reduce the incident rate.

The metric for predictability is the service provider's equipment utilization rate, which is the average number of usage hours for a particular equipment type divided by the number of hours in the reporting period:

U=(Hᵤ/E)/Hᵣ,

where Hᵤ is the number of equipment usage hours in the reporting period, E is the number of available units of a particular equipment type, and Hᵣ is the total number of hours in the reporting period. (Higher predictability increases utilization rate because the service provider can reduce the total number of units of a given type, which in turn increases the average number of usage hours for the remaining units.) Utilization numbers are gathered through automated scheduling and tracking systems and auditable equipment usage logs. The service provider can increase the utilization number by eliminating extra units. The operator can indirectly control the utilization number by reducing the peak number of units required in each reporting period. (Techniques for reducing peaks are discussed further below.)

Since indirect control may be regarded as inadequate, a separate, operator-based utilization rate may also be used. The operator utilization rate may be computed as the number of operator usage hours divided by the product of the peak number of units required by the operator and the number of hours in the reporting period:

Uₒ=Hₒ/(P Hᵣ),

where Hₒ is the number of operator usage hours in the reporting period, P is the peak number of units of a particular equipment type required by the operator during the reporting period, and Hᵣ is the total number of hours in the reporting period. This utilization number can be directly controlled by the operator by scheduling jobs evenly throughout the week to minimize the peak number, i.e., the maximum number required at the same time. Both utilization metrics or a composite utilization metric may be employed for determining incentives. By using both utilization metrics, for example, the operator utilization rate can be used to create an incentive for level loading by the operator, while the overall utilization rate can be used to create an incentive for the provider to reduce unnecessary equipment inventory (thereby reducing costs).

However, a potential verification issue arises because numbers such as utilization may be considered sensitive by the service provider because the oilfield operator is typically not the only customer, and the operator may gain inside information about competitors through verification of this metric. Such sensitivity issues may be addressed by the formation of a “management team” of selected representatives from both parties. The management team members are obligated to abide by a strict nondisclosure agreement that requires any information acquired by verification procedures be kept confidential even from other company members, and executive leadership personnel are excluded from the management team. Alternatively, the management team may comprise one or more independent parties to perform such verification procedures.

FIG. 4 illustratively lists total cost per BOE (Barrel Oil Equivalent) as a metric for operator profits. The total cost is the operator's total annual expense divided by the amount of produced hydrocarbons as expressed in units of barrel oil equivalent. The total cost includes such expenses as operating leases, drilling expenses (including intangible expenses such as depreciation), well completion expenses, materials expenses, processing fees, plant operating expenses, environmental expenses, taxes, and overhead. Though the total cost per BOE measures only one component of the operator's profit calculation (the other part being income), it measures the component that can be most directly influenced by the combined behavior of the parties. The operator's existing accounting system systematically tracks the total cost expenses and the amount of produced hydrocarbons. Again, such numbers may be considered sensitive and verification may be accomplished via independent auditors or by the management team.

The metric for the service provider's return on investment is the total burdened cost for each component of the services provided. The unburdened total cost is computed on an usage hour basis, and for personnel directly involved in delivering and/or using equipment and materials, it includes salaries, benefits, and wages. For equipment, the unburdened total cost includes transportation, maintenance, fuel, depreciation, insurance, and other direct costs. For products and materials, the unburdened total cost is the acquisition or direct manufacturing cost.

The total burdened cost is then determined from the unburdened cost using an overhead multiplier. The overhead multiplier may be determined in any mutually acceptable fashion, but it accounts for the indirect costs of the services provided, e.g., administrative costs, advertising costs, and any cost incidental to providing the services but not directly attributable to a particular service component. One method for determining the overhead multiplier is to determine the total costs of services provided in a previous reporting period and dividing the total costs by the direct costs and usage hours in that reporting period. The service provider's existing accounting system systematically tracks such expenses, though adaptations may be needed to allocate costs to specific service components. Again, such numbers may be considered sensitive and verification may be accomplished via independent auditors or by the management team.

The metric for technology innovation is technology demand. Technology demand is simply the amount (or hours) of a new technology that is sought in a given reporting period. The demand can be influenced by the service provider by creating sought-after technology innovations, and the oilfield operator influences the demand by seeking the most appropriate technology for the task at hand. The existing order system for service provider calls can provide a systematic measure of this metric, and verification may be provided by independent auditors or the management team.

The metric for accurate cost allocation is an accumulated differential percentage. One or more of the other metrics employed for measuring how aligned interests are served may be based on estimates or historical data, and inaccuracies may reduce incentives for beneficial behavior changes. Accordingly, a separate incentive for accurate cost allocation may be employed to address this issue. The accumulated differential percentage is the accumulated errors in costs for the previous reporting period. Both parties can cooperate to reduce cost errors, and verification may be performed by independent auditors or the management team.

In block 110 (FIG. 1), the party representatives specify incentives based on the metrics determined in block 108. The incentives are designed to shape the parties' behavior to best serve the aligned interests as measured by the metrics. Note that a one-to-one relationship between incentives and metrics is not necessary. To the contrary, one incentive may depend on multiple metrics and, conversely, multiple incentives may depend on one metric. In any event, the incentive should be chosen to make the desired behaviors clear.

FIG. 5 shows an illustrative set of incentives for the oilfield operator—service provider example. The set includes a realized savings percentage, a utilization credit, a profit margin, and new technology revenue. Each of these is discussed in turn below.

The realized savings percentage identifies savings by the oilfield operator for services received from the service provider. The realized savings percentage is directly based on invoice amounts, which impact the metric for operator profits. The realized savings percentage is the difference between total traditional invoice amount and total aligned-interest invoice amount, divided by total traditional invoice amount for the reporting period:

S=(T−A)/T,

where T is the sum of traditional invoice amounts for the reporting period and A is the sum of aligned-interest invoice amounts for the reporting period. The traditional invoice amounts serve as a baseline for measuring savings, and to that end, traditional invoices continue to be generated by the service provider for provided services. Aligned-interest invoices provide for accurate cost allocations to encourage the oilfield operator to reduce the provider's overhead costs.

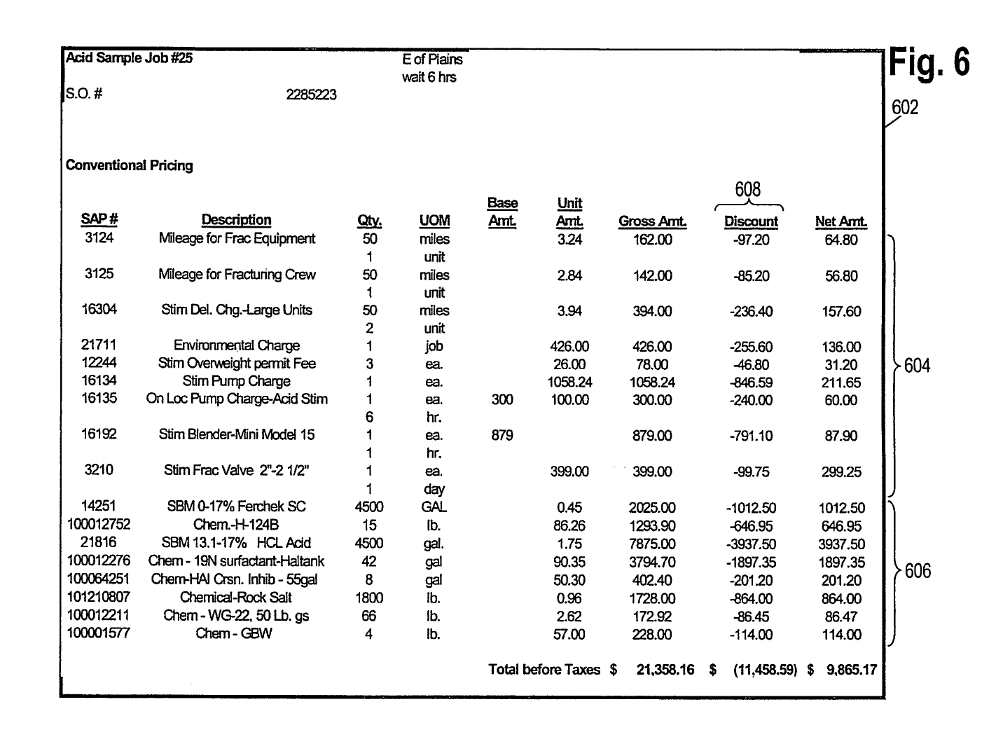

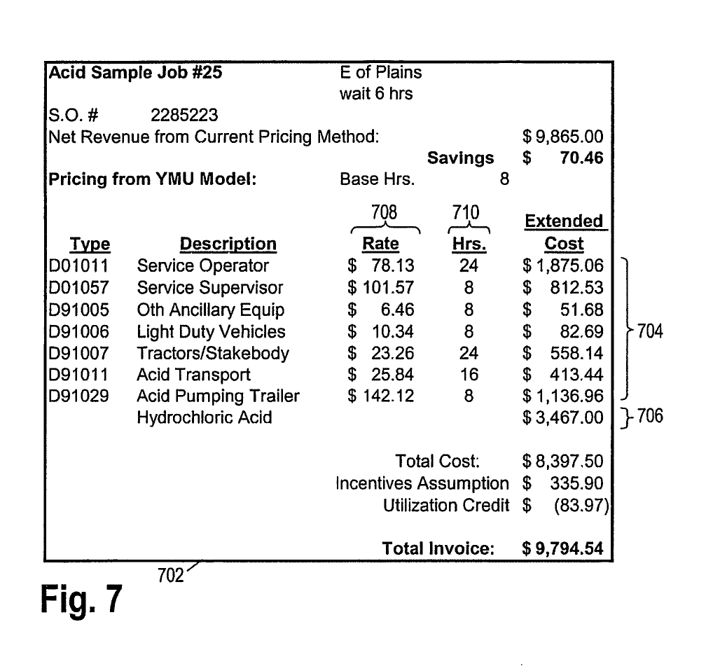

FIG. 6 shows an illustrative traditional invoice 602. In the traditional invoice, the equipment and personnel prices 604 are set at nominal amounts, while the materials prices 606 are be set with high margins to offset overhead costs for the equipment and personnel. (Discounts 608 are at rates negotiated between the parties in accordance with a varying balance of economic power. They may be maintained at historical levels or adjusted in accordance with average discounts negotiated for other relationships.) Thus the traditional invoicing method may inadvertently decrease efficiency through a misallocation of costs. Specifically, the nominal prices for personnel and equipment may encourage operators to secure large lead times to minimize costs associated with arrival delays. Such lead times may increase the provider's overhead, forcing the service provider to increase price margins on the materials.

FIG. 7 shows an illustrative aligned-interest invoice 702. In the aligned invoice, the equipment and personnel prices 704 are based on the product of hourly prices 708 and gate-to-gate hours 710. The hourly prices 708 are the product of the total burdened cost and a profit multiplier, and the gate to gate hours are a measure of the true time required to perform a service call including transport time. This invoicing method makes the service provider's costs more visible to the oilfield operator, enabling the oilfield operator to increase efficiency. In the traditional invoicing method, the amounts allocated for personnel and equipment may be a low percentage of the total price, whereas the aligned-interest invoicing method reveals that equipment and personnel might actually represent a majority of the total cost.

While protecting the service provider by ensuring that the provider's costs are covered and an acceptable return on investment is received, the more accurate cost allocation in aligned-interest invoices enables the oilfield operator to more efficiently balance the hourly costs of personnel and equipment against the costs of operating delays, transportation planning, advance scheduling, etc. To increase the realized saving percentage, the operator can work to reduce dead time (i.e., unproductive time spent waiting at the well site), and can work to reduce transport time by job stacking (i.e., scheduling multiple jobs adjacent in time to reduce travel time back to the yard) and by improved scheduling (e.g., putting the multiple jobs in a geographic sequence that minimizes travel time).

A second incentive for the oilfield operator is a utilization credit, and it is tied to the metric for predictability. The utilization credit reflects the service provider's improved ability to obtain other customers when the oilfield operator's predictability is increased. The credit may not be subject to a closed-form computation, and accordingly, it may be determined as an entry in a table of negotiated values based on the service provider's utilization rate and the operator-specific utilization rate. The table may reveal trends toward increasing credit for increasing operator-specific utilization rates and decreasing credit for increasing service provider utilization rates. (The decreasing credit trend may serve as an incentive for the service provider to reduce unnecessary inventory, thereby reducing overhead costs.) The utilization credit may be expressed in the form of a percentage discount that is applied to invoices in a current quarter based on utilization rates from the previous quarter. The illustrative invoice of FIG. 7 includes a line-item for a 1% utilization credit discount.

For the service provider, the first incentive is the profit margin, which directly based on the operator's realized savings percentage. The realized savings percentage is a result of increases in efficient operator behaviors and a reduction in burdened costs for service components. The base profit margin is determined by the profit multiplier that is used to calculate the invoice prices from the burdened costs of the service components. The profit multiplier is set in a manner that allocates a portion of any gains in savings to improve the service provider's return on investment, while preserving a portion of that gain in realized savings for the operator's benefit. As one example, the service provider may be allocated half of any gain in savings above a baseline savings amount. The relationship between realized savings percentage and profit multiplier may not be subject to a closed-form computation, and accordingly, the profit multiplier may be determined as an entry in a table of negotiated values.

A second incentive for the service provider is new technology revenue, which is tied directly to the metric for innovation. Newly-developed technology may be invoiced in accordance with prices charged to other customers for up to some agreed time limit from the introduction of the new technology. As one example, the time limit may be three years. To protect the operator from abuse of this incentive, a cap may be placed on the invoiced amounts for new technology. For example, the new technology cap may be a fixed percentage of total invoiced amounts per quarter.

In the oilfield operator—service provider example, the service provider's burdened rate for any given service component may be adjusted from quarter to quarter based on the accumulated difference percentage for the previous quarter. Thus when a burdened rate is determined to be 1% too low, an upward adjustment of 1.5% may be provided the next quarter to compensate for the error. The adjustment may be provided as a separate line item to avoid propagating errors into future quarters.

As another example, the listed incentives may be augmented based on other metrics for the aligned interests. For example, the service provider's profit multiplier (or profit margin) may be increased or decreased by an amount that is computed from the incident rate, the operator-based utilization rate, and/or the operator's total cost per BOE. To determine the dependence of the profit multiplier on various aligned interest metrics, a predictive business model may be used. The predictive business model is a mechanism for predicting the effects of changes in metrics on revenue and profits. In its simplest form, the predictive business model may take the form of a spreadsheet having accounting numbers taken from a representative business quarter. The accounting numbers may include required materials, equipment, and personnel hours for services performed that quarter, along with costs and revenues for providing the materials, equipment, and personnel. Cost and revenue changes for each service component may be calculated for different metric values, so that, e.g., the overall effect of utilization on costs and revenue can be determined. (If an exact relationship between different metric values and service component revenues or costs is unknown, the relationship may be estimated based on general principles or data from past quarters that exhibit variation in the metrics.) With knowledge of the overall metric effects, a savings amount can be calculated and allocated between the parties, e.g., in the form of a profit multiplier dependence on the utilization and other metrics. Various different profit multiplier dependencies may be tested in the model to verify their feasibility.

Having determined incentives in block 110 (FIG. 1), the parties' representatives then specify a relationship monitoring process. As mentioned previously, many of the numbers for various metrics and incentives may be considered sensitive by either of the parties, and hence a secure verification procedure may be established using independent auditors and/or a management team that are subject to strict confidentiality requirements. The monitoring process may include specified review intervals for the data gathering and metric computations.

In block 114, the metrics, incentives, and monitoring procedures are set down in an agreement that formalizes the business relationship. The agreement serves to memorialize the terms of the relationship, specify how mutually agreed changes can be incorporated, and set forth a dispute resolution procedure. In block 116, the parties implement the terms of the agreement. In the oilfield operator—service provider example, the oilfield operator requests service calls that are performed by the service provider. The service provider then bills the oilfield operator using aligned-interest style invoices. A management team monitors the gathering of information upon which the metrics and incentives are based.

In the course of implementing the relationship, it is expected that new interests may be discovered, metrics may become unsuitable, or other changes may be needed. In block 118 the management team determines whether an adjustment to the agreement is needed, and if so, the parties repeat blocks 104-118. As one example, changes in economic conditions may require that the incentive calculations be modified.

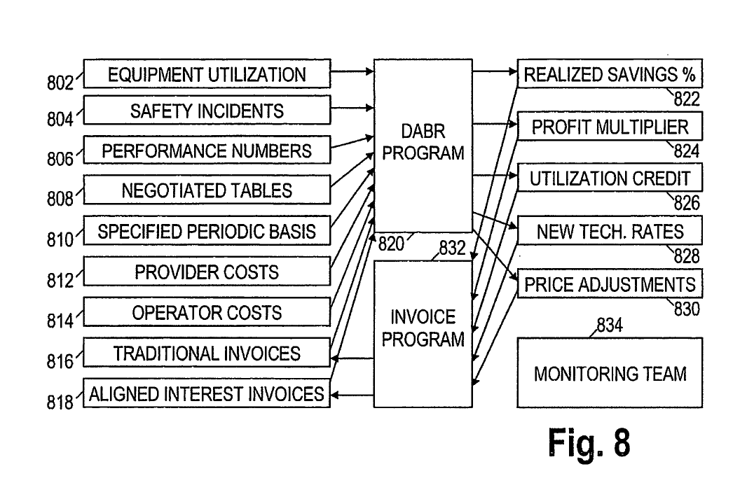

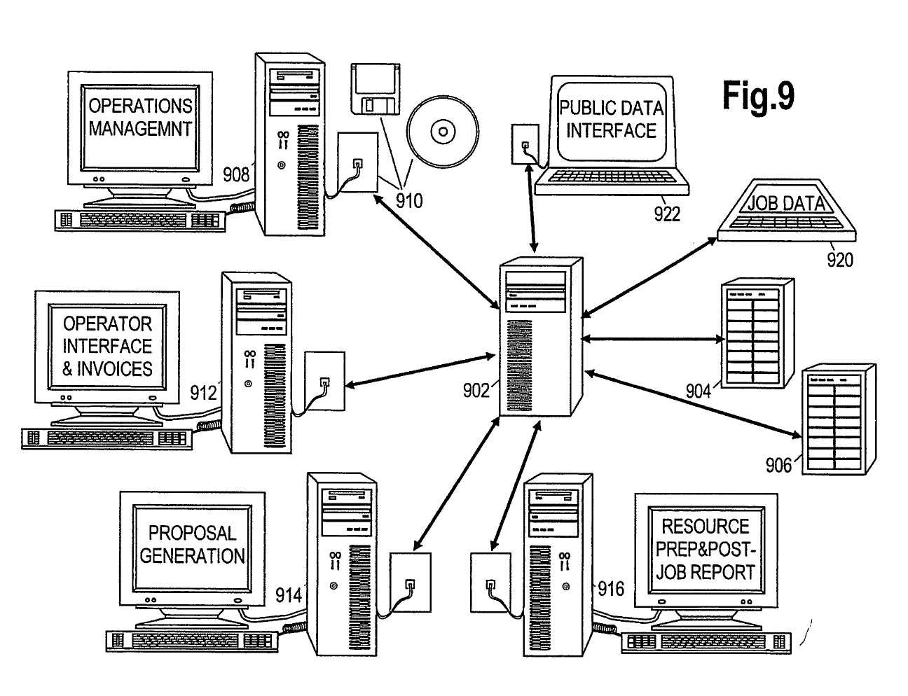

FIG. 8 shows a block diagram of an illustrative business interest alignment system for the oilfield operator—service provider example. Inputs 802-818 include metrics such as equipment utilization 802, safety incidents 804, performance numbers (determined by satisfaction survey) 806, provider costs 812, and operator costs 814, and include parameters such as the negotiated incentive tables 808 and the reporting periods 810. Traditional invoices 816 and aligned-interest invoices 818 are included as both inputs and outputs of the system. A dynamically aligned business relationship (DABR) program 820 processes the inputs to calculate incentives 822-830. The incentives include the realized savings percentage 822, the profit multiplier 824, the utilization credit 826, the new technology rates 828, and the price adjustments 830. An invoice program 832 applies the calculated incentives from a previous recording period to rendered service data (not shown) from a current reporting period to produce a traditional invoice 816 and an aligned-interest invoice 818. A monitoring team 834 (e.g., either the management team or independent auditors) periodically reviews the gathered data and computations made therefrom.

FIG. 9 shows an illustrative implementation of a business interest alignment system for the oilfield operator—service provider example. One or more servers 902 provides access to one or more databases. Data on storage device 904 may form a financial database for tracking service provider costs that are employed in determining total burdened costs for various materials and service components. Data on storage device 906 may form a scheduling and maintenance database for tracking availability of personnel and equipment units. Though shown as separate databases, the databases may be consolidated into a single database or further subdivided. Server 902 may represent a single server, multiple independent servers, or a distributed server as implemented by many cooperating processor units.

An operations management computer 908 may be used by the service provider to install and manage the database(s) on server(s) 902. The operations management computer 908 is further employed to install the DABR program 820 and the invoice program 832 (as represented by information carrier media 910). These programs may be computation processes incorporated into the database management software, or they may be independent programs that gather the needed data from the database management software to compute the desired values. The programs may be executed by server(s) 902 or by the operations management computer 908.

An operator interface computer 912 may be used by the oilfield operator 912 to obtain and review service invoices, and may further provide access to supporting numbers for the invoices under appropriate confidentiality controls. A proposal generation computer 914 may be used by the service provider to field service calls and assemble an order for the equipment and personnel to perform requested services. A resource preparation and post-job reporting computer 916 may be used by the service provider to document the assembly of a service package having the necessary personnel, equipment, materials, and transport to perform a scheduled service call, and to further document the return and storage of such items after the job is complete. A job data entry unit 920 may be used to document job events such as arrivals, changes, delays, safety incidents, and departures at the job site. Finally, a public data interface 922 may be used by external users to obtain publishable information for public relations, SEC (Securities Exchange Commission) compliance, and customer service. Each computer 908-922 may represent multiple independent computers that offer the described functionality.

The foregoing description provides discloses methods and systems for aligning interests of two parties in a relationship. In the context of an oilfield operator and service provider, the disclosed methods provide for an invoice pricing structure that accurately allocates costs for various service components. The oilfield operator can work to reduce invoice prices directly by eliminating dead time and minimizing associated travel times, and indirectly by increasing utilization by level-loading (scheduling jobs evenly throughout the week) to reduce the provider's burdened costs. The new invoice pricing structure is compared against traditional pricing as a baseline cost for the services and materials, and the resulting savings is measured. The service provider cooperates with the oilfield operator to reduce invoice prices in return for an increased profit margin based on the savings realized by the oilfield operator. The determination of a profit multiplier is based on a strategy that allocates a portion of the savings to the service provider as an increased profit multiplier. Various other adjustments to prices and profit margins provide incentives to the parties to cooperate in serving each other's interests. The incentives can be extended to the individual employees of both organizations by basing employee bonuses on the same metrics underlying the companies' incentives.

Numerous variations and modifications will become apparent to those skilled in the art once the above disclosure is fully appreciated. It is intended that the following claims be interpreted to embrace all such variations and modifications.

What is claimed is:

1. A method of profit sharing between business entities including an oilfield operator and a service provider, the method comprising:
determining a baseline cost for a service, wherein the baseline cost is expressed as an invoice calculated in accordance with a non-cost-based method, and wherein the service includes at least one of a fracturing service, an acid service, and a cementing service;
determining a savings relative to that baseline cost, wherein the savings is determined by:
obtaining a product of a burdened service cost and a profit multiplier, wherein the burdened cost is mutually determined by the business entities and adjusted on a quarterly basis based on an accumulated difference percentage from a preceding quarter, and wherein the product is expressed as an hourly rate; and
multiplying the product by a number of gate-to-gate hours, wherein the gate-to-gate hours is an amount of time required by the provider to provide a service including transportation from a holding facility, wherein the transportation time included in gate-to-gate hours is apportioned from among all services provided in a round trip to and from the holding facility; and
allocating a portion of that savings to a provider of that service or product by increasing the profit multiplier, wherein the profit multiplier is further based on additional metrics including an operator-based utilization rate, a safety incident rate, and an operator cost per barrel of oil equivalent (BOE), and wherein the profit multiplier dependence on at least one of the additional metrics is determined using a predictive business model.

2. The method of claim 1, further comprising:
generating a utilization credit based on an overall utilization rate to reward the operator for level loading; and
excluding new technology from burdened cost rate pricing.

3. An information carrier medium that communicates software to a computer, wherein the software when executed effects an invoicing method that comprises:
showing a cost rate for each of various components of a service, wherein the cost rate is a product of a burdened cost rate and a profit multiplier, wherein the burdened cost rate is mutually determined by an oilfield operator and a service provider and adjusted on a quarterly basis based on an accumulated difference percentage over a preceding quarter, wherein the service includes at least one of a fracturing service, an acid service, and a cementing service;
showing an associated gate-to-gate time required by a provider to provide each of the service components and a consequent cost for each of the service components, wherein the gate-to-gate time includes transportation time from a holding facility, wherein the transportation time included in the gate-to-gate time is apportioned from among all services provided in a round trip to and from the holding facility;
showing a total service cost calculated from the cost rate and the associated gate-to-gate time; and
comparing the total service cost to a baseline cost to determine a savings, wherein the baseline cost is expressed as an invoice calculated in accordance with a non-cost-based method, wherein the profit multiplier for a current reporting period is determined from an accumulation of such savings over a preceding reporting period, and is further determined based on additional metrics including an operator-based utilization rate, a safety incident rate, and an operator cost per BOE, and wherein the profit multiplier dependence on at least one of the additional metrics is determined using a predictive business model.

4. The information carrier medium of claim 3, wherein the invoicing method further comprises:
generating a utilization credit based on an overall utilization rate to reward a receiver of a service for level loading; and
excluding new technology from burdened cost rate pricing.
